(19) United States
(12) Patent Application Publication
(10) Pub. No.: US 2009/0278987 A1
(43) Pub. Date: Nov. 12, 2009

(54) USER INTERFACE FOR CONSUMER ELECTRONIC PRODUCT

(75) Inventor: Jianyun Liu, Nashville, TN (US)

Correspondence Address: NIXON & VANDERHYE, PC, 901 NORTH GLEBE ROAD, 11TH FLOOR, ARLINGTON, VA, 22203, US

(73) Assignee: TOSHIBA AMERICA CONSUMER PRODUCTS, Wayne, NJ (US)

(21) Appl. No.: 12/350,155

(22) Filed: Jan. 7, 2009

Related U.S. Application Data
(60) Provisional application No. 61/006,312, filed on Jan. 7, 2008.

(51) Int. Cl. H04N 5/50; H04N 5/445

(52) U.S. Cl. 348/569; 725/44; 348/E05.097

(57) ABSTRACT

Example systems and methods of a television user interface include a channel list vertically disposed on a television screen, an input device for receiving inputs for selecting a channel on the channel list, and an information bar horizontally disposed on the television screen in correspondence with a selected channel, wherein the information bar provides information about programming on the selected channel.

### CROSS-REFERENCE TO RELATED APPLICATIONS

This application claims the benefit of U.S. provisional application No. 61/006,312, filed Jan. 7, 2008, the contents of which are incorporated herein in their entirety.

This application is related by subject matter to U.S. application Ser. No. 11/434,210, the contents of which are incorporated herein in their entirety.

### BACKGROUND AND SUMMARY

The subject application generally relates to a user interface for a consumer electronic product such as a television.

The increasing complexity of consumer electronic products such as televisions and of the systems in which these products are incorporated (e.g., cable and satellite television systems with hundreds of channels) make it more difficult for users to use the products and take full advantage of the functionality that these products provide. Operations of these products that in the past were relatively straightforward and simple have become more difficult.

For example, it can be difficult to channel “surf” or “browse” to find programs of interest when a television receives hundreds of channels. In addition, with the advent of digital channels, even the task of simply tuning to a channel can involve entering a channel and sub-channel (such as 118-1) and can take up to five or more key presses on a keypad of a remote control or a front panel. Thus, surfing from one channel to another by entering different channel numbers is time-consuming and prone to error since so many numbers must be entered to surf to a series of different channels. When there are hundreds of channels and each channel may involve both channel and sub-channel numbers, even remembering which channels to surf to can be a difficult task.

Example systems and methods of a television user interface described herein include a channel list vertically disposed on a television screen, an input device for receiving inputs for selecting a channel on the channel list, and an information bar horizontally disposed on the television screen in correspondence with a selected channel, wherein the information bar provides information about programming on the selected channel.

### BRIEF DESCRIPTION OF THE DRAWINGS

FIG. 1 is a generalized block diagram of an illustrative television in which the example interface may be implemented.

FIG. 2 shows an example layout of keys and buttons for remote control 150.

FIGS. 3 and 4 show respective examples of a user interface in accordance with the systems and methods described herein.

FIG. 5 schematically shows modules of an example user interface in accordance with the systems and methods described herein.

### DETAILED DESCRIPTION OF EXAMPLE EMBODIMENTS

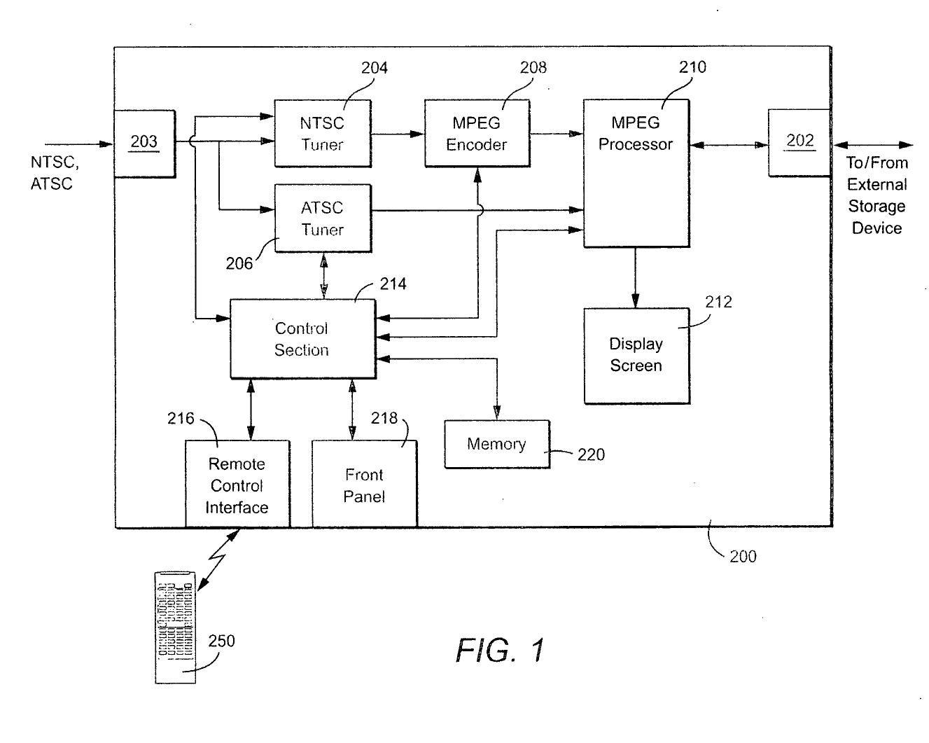

FIG. 1 is a highly generalized block diagram of a television in which the example interface described herein may be implemented. The details of the television are provided by way of example only and it will be readily apparent that the interface may be implemented in a wide variety of televisions of different configurations, both analog and digital.

An input 103 of the television receives NTSC and ATSC signals. The NTSC signals are supplied to an NTSC tuner 104 and the ATSC signals are supplied to an ATSC tuner 106. Other inputs (not shown) may also be supplied to the television. For example, the television may receive HDM1 signals or the output from a DVD player. The output of NTSC tuner 104 is supplied to an MPEG encoder 108 which MPEG encodes the tuned NTSC signal. The outputs of ATSC tuner 106 and MPEG encoder 108 are supplied to an MPEG AV processor 110. MPEG AV processor 110 processes the MPEG transport stream from the ATSC tuner 106 and/or MPEG encoder 108 and supplies a display signal to display screen 112 and a sound signal to speakers 120. MPEG AV processor 110 also selectively outputs an MPEG transport stream to and receives an MPEG transport stream from an external storage system via interface 102. The external storage system may, for example, include a hard disk drive (HDD) recording device, a DVD recording device, or an HDD/DVD recording device. Generally speaking, MPEG AV processor 110 is a standard processing device used in conventional digital integrated televisions, monitors and set-top box (STB) units that receives MPEG compressed AV data and decompresses and processes the AV data for output via display screen 112 and speakers 120.

A control section 114, including a CPU, for example, controls the overall operations of television 100. In general, control section 114 may include, for example, a microprocessor, a microcontroller, a processor, a controller, an application specific integrated circuit (ASIC), logic circuitry, a state machine and/or combinations thereof. Control section 114 may be supplied with inputs from a user via a remote control interface 116 (e.g., a wireless infrared receiver) for a remote control 150 (e.g., an infrared remote control) and front panel keys 118. MPEG AV processor 110 may selectively block output of audio and/or video in accordance with control signals from control section 114.

Memory 120, which may be a combination of volatile and non-volatile semiconductor memory, stores various operating programs and user settings (e.g., rating level(s) set by parents) used by control section 114 to control the operation of television 100. For example, memory 120 may include ROM storing an operating program for execution by the control section 114 to implement the systems and methods described herein. This operating program may provide for control of tuners 104, 106; control of MPEG AV processor 110 to generate displays for display on display screen 212 and sounds for output via speakers 120; processing of inputs supplied by a user via front panel 118 and/or remote control 150; and the like. Memory 120 may also include SDRAM for use by control section 114 during execution of the operating program.

Television 100 may also be provided with an electronic program guide. Generally speaking, an electronic program guide uses program guide data transmitted to the television to provide the user with on-screen displays of television program schedules. For example, the on-screen display may be in the form of a grid in which channels are arranged vertically and time extends horizontally. Titles of programs are shown in cells in the grid and the horizontal dimension of the cell is indicative of the length of the corresponding program. The electronic program guide may also enable a user to select programs from the grid (or from some other display of program titles) for viewing and recording. In the case of selecting a program from the program guide for viewing, the television is controlled to tune to the channel showing the selected program. In the case of selecting a program for future recording, a program timer is generated with relevant recording information (e.g., start time, end time, channel). At the program start time, the television is controlled to tune to the selected channel and command(s) may be issued to turn on and place a recording device in record mode (e.g., to the external storage device via interface 102). At the program end time, command(s) may be issued to stop the record mode and turn off the recording device. In addition, electronic program guides also often provide the capability of displaying listings of programs by themes and titles. Electronic program guides are available from various providers including Gemstar-TV Guide.

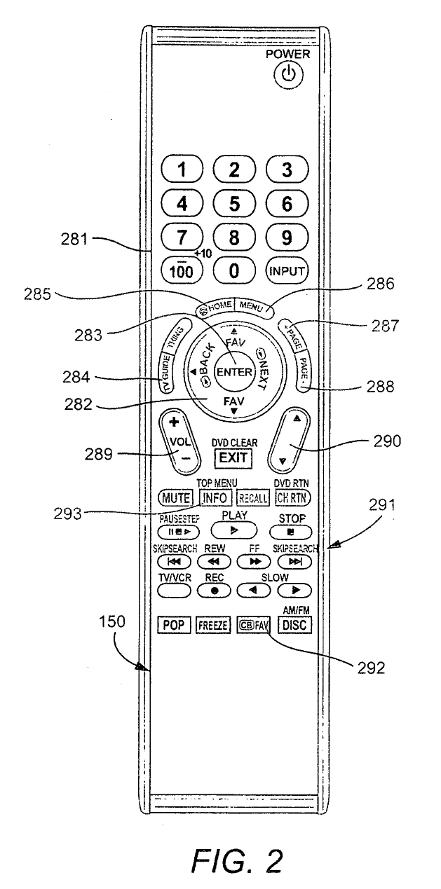

FIG. 2 shows an example layout of keys and buttons for remote control 150. The keys or buttons of remote control 150 may be appropriately labeled to assist the user in selecting a desired function. Alternatively or additionally, television 100 may provide one or more displays that inform the user which key(s) or button(s) should be actuated to input desired commands. Other types of inputs such as voice inputs may also be used to input commands in certain implementations.

Remote control 150 includes a numeric keypad 281 including the numbers 0-9. Keypad 281 also includes a “-/100” key for use in entering channel numbers greater than 100 and a delimiter for separating major and minor channel numbers (e.g., channel 125-3). An “Input” key is provided for use in switching between different inputs to television 100 (e.g., different antennas, different video inputs, different devices connected to the television, etc.). Remote control 150 also includes a navigation switch 282 that provides for up, down, left and right navigation through menus, program guides, and the like. An enter key 283 is also provided. Various keys are provided around part of the periphery of navigation switch 282. A “program guide” key 284 causes a program guide to be displayed. A “home” key 285 causes television 200 to tune to a HOME channel. A “menu” key 286 causes television 200 to display an initial menu screen for accessing various features of television 200. A “Page+” key 287 and a “Page−” key 288 provide for navigation through menus, program guides, etc. A volume up/down key 289 and a channel up/down key 290 permit the user to set the volume level and to select television channels. A DVD/VCR keypad 291 allows the user to control a DVD player and/or a VCR. A “CB/Fav” key 292 accesses a favorite channel feature. An “Info” key 293 can be pressed by a user to access additional information on a particular topic.

It will of course be appreciated that the function(s) associated with the various keys and buttons of the remote controls described above may vary depending on the state of television 100 (e.g., watching television, moving through menus, making menu selections, etc.). Moreover, the layout of the keys and buttons shown in FIG. 2 is not intended to be limiting in any way and various designs for laying out these keys and buttons may be adopted.

This application describes example interfaces in which the channel browser described in application Ser. No. 11/434,210 (the contents of which are incorporated herein in their entirety) is combined with an information bar (referred to herein as “Info+ Bar”) application, and other sub-applications such as a TickerTape are allowed to gain focus. The channel browser described in application Ser. No. 11/434,210 generally operates as described therein, but perhaps with some key re-assignments. Also, the channel browser bar may be displayed vertically instead of horizontally. When a channel on the channel browser bar is highlighted, a method of signaling (for example, an event message) is used to command the Info+ Bar to display data pertaining to the highlighted channel. By modularizing each application, the channel browser does not need to know the existence of the Info+ Bar, and vice-versa. Each application can be developed separately.

Such an arrangement:
Provides a centralized navigation interface that manages lists of channels, inputs, and other elements, while showing channel information.
Provides a modular design that allows existing applications to co-exist with new developing applications.
Provides method of communication/signaling among applications and allowing multiple applications to share focus on screen.

| | |
|---|---|
| GUI | Graphical User Interface |
| Channel Browser | A GUI application and convenience feature used to navigate |
| | lists of channels or inputs, or other medias, and manages the |
| | organization of the lists. |
| Info + Bar | A GUI application that displays information pertaining to the |
| | time and programming of the currently selected channel, |
| | including, but not limited to, the upcoming show schedules, |
| | program genres, ratings information, show descriptions, and |
| | time remaining. |
| Ticker Tape | A GUI application that displays scrolling information |
| | pertaining to the time and programming of upcoming |
| | programming and news pertaining to the currently selected |
| | channel. |
| Help Bar | A GUI application that displays functional information and |
| | descriptions. |
| Module | An independent/standalone GUI application, that may or may |
| | not be required to be activated separately from other |
| | applications. |
| Message | An information structure passed from one GUI application to |
| | another. |
| Signaling | Method of passing messages from one module to another in |
| | order for two or modules to interact with each other. |
| State-machine | The parent architecture of the GUI applications and uses |
| | signaling methods to drive events. |
| CB/FAV | A key on the TV's remote |

### Channel Browser Module

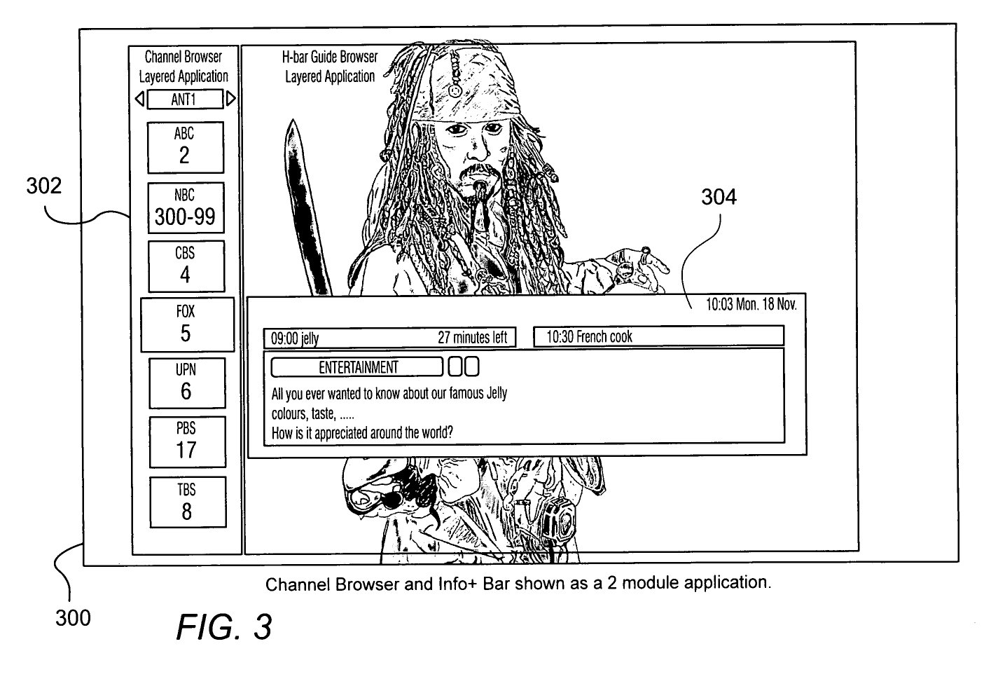

The Channel Browser manages lists of channels, inputs, and other media elements. When a channel is selected in a list, a message is sent (e.g., a message denoted as MSG_NEW_CHANNEL FOCUS) along with an identifier (ID) of the channel to a state-machine. When a new channel is selected, a fixed focus may remain at the top of the list on the current channel while the list shifts either up or down depending on the direction the user is navigating. The Info+ Bar, which receives the message, is displayed next to the selected channel as shown by way of example in FIGS. 3-5 and discussed in greater detail below. Pressing CB/FAV key 292 on remote control 150 switches to the next list, displays the Channel Browser, or puts focus back on the Channel Browser.

Channel Browser lists (AUTO turns the list off if there are 0 items in the list):

| | CB Setup | Default Setting |
|---|---|---|
| All Programs | AUTO/ON/OFF | AUTO |
| TV | AUTO/ON/OFF | AUTO |
| Radio | AUTO/ON/OFF | AUTO |
| Teletext | AUTO/ON/OFF | AUTO |
| (Bouquet) | AUTO/ON/OFF | AUTO |
| History | ON/PWR CLEAR/OFF | PWR CLEAR |
| Input | ON/OFF | ON |
| FAV1 | ON/OFF | ON |
| FAV2 | ON/OFF | OFF |
| FAV3 | ON/OFF | OFF |
| FAV4 | ON/OFF | OFF |
| (CE-Link) | ON/OFF | OFF |

UP/DOWN ARROWS: navigates a list
CH P UP/DOWN: pages
Hold CB/FAV 3 sec.: favorite channel programming.

### Info+ Bar Module

The Info+ Bar provides channel information for the channel selected in the Channel Browser. When the Info+ Bar receives a display signal from the Channel Browser (e.g., MSG_DISPLAY_INFO_BAR), the Info+ Bar is displayed on screen. When it receives a signal with information (channel ID) about the current channel (e.g., MSG_NEW_CHANNEL_FOCUS), it retrieves data from a database (e.g., a program guide database) that contains information about the channel. This data may include, for example, program title, program summary, program rating, program cast, program start time, program end time and program duration data. When the Info+ Bar receives a close signal from the Channel Browser (e.g., MSG_CLOSE_INFO_BAR), the state-machine removes it from the display. The Info+ Bar receives focus along with the Channel Browser. This means that by pressing the left or right arrow keys on the remote, the user can see future schedules on the current channel selected in the Channel Browser.

LEFT/RIGHT may be reserved for schedule activity in Info+ Bar module.

### Ticker-Tape Module

The Ticker-Tape module gets focus by pressing a specified remote control key. The key press causes a message to be sent to the state-machine (e.g., MSG_FOCUS_TO_TICKER_TAPE), which determines that the focus needs to shift to the Ticker-Tape. All navigation keys are then directed to the Ticker-Tape. While in the Ticker-Tape, if the user presses the CB/FAV key on the remote, all navigation keys are then redirected back to the Channel Browser by a message (e.g., MSG_FOCUS_TO_CH_BROWSER).

LEFT/RIGHT may be reserved for navigating the Ticker-Tape.

### Help Module

This module displays help at the bottom of the screen. This application receives no focus, but may receive signal messages, to display different sets of help buttons. For example, the channel browser may have the keys perform a different set of functions from the Ticker-Tape.

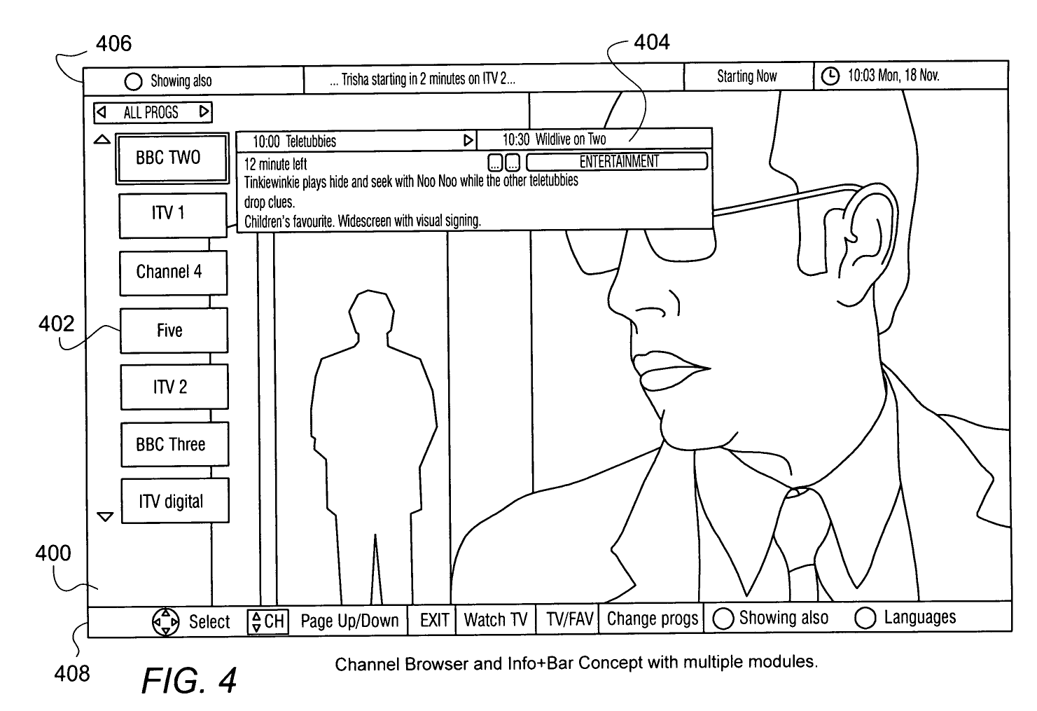

FIGS. 3 and 4 show example implementations of the modules discussed above.

As shown by way of example in FIG. 3, a channel browser list 302 for the input ANT 1 (Antenna 1) is vertically oriented on television screen 300. The Info+ Bar 304 is horizontally disposed adjacent to the channel highlighted in the channel list, i.e., channel 5. A channel can be highlighted in various ways. In FIG. 3, the highlighted channel is enlarged relative to the other channels in the list.

Different channel lists may be displayed by pressing the left/right arrows on navigation switch 282 when the channel browser has focus. These other lists may include an all programs list, one or more favorite channels lists, a history (of tuned channels) list, and the like.

Info+ Bar 304 provides information about the program on the highlighted channel including, for example, start time (i.e., 9:00 PM), program title (i.e., “jelly”), time remaining in the program (i.e., 27 minutes), a program category (i.e., entertainment), and a program summary. Other information (not shown) may be displayed such as program rating, cast information, availability of closed captioning, availability of stereo sound, etc. The current time and date are shown in the upper right hand corner of Info+ Bar 304.

The Info+ Bar 304 also displays the title and start time of the next program showing on the highlighted channel. In the FIG. 3 example, the next program is entitled “French Cook” and begins at 10:30 PM. When Info+ Bar 304 has focus, navigation key 282 may be used to navigate forward in time and highlight future programs that will be shown on the current channel. The program information in the text box is updated to display information about the future programs which are highlighted. While FIG. 3 shows a future program on the highlighted channel. Info+ Bar 304 may be configured to permit review of prior programs on the channel to the extent information about such programs remains available in the program guide database.

As can be seen in FIG. 3, the channel browser list 302 and Info+ Bar 304 are overlaid on the video shown on the currently-viewed channel. These elements are partially transparent so that the video over which the elements are laid can be at least partly seen therethrough.

FIG. 4 shows another example implementation of the systems and methods described herein in which features in addition to channel browser bar 402 and Info+ Bar 404 are provided on television screen 400. As mentioned above, TickerTape 406 is a GUI application horizontally disposed along the top of television screen 400 that displays scrolling information pertaining to the time and programming of upcoming programs and news pertaining to the currently selected channel. By way of example, TickerTape 406 in FIG. 4 identifies a program starting on another channel in two minutes.

FIG. 4 also shows a help bar 408 which, as noted above, is a GUI application that displays functional information and descriptions. In this case, help bar 408 provides information about how to make selections, page up/down, return to watching a television program, change programs, etc.

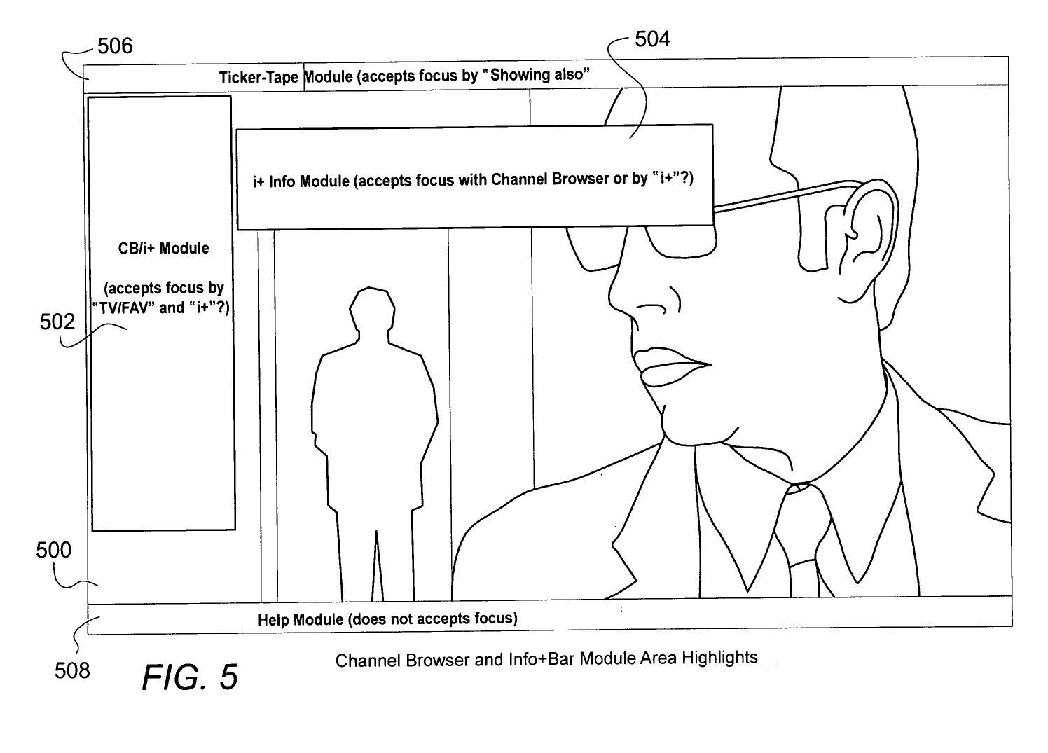

FIG. 5 schematically shows channel browser 502, Info+ Bar 504, TickerTape 506 and help bar 508 arranged on television screen 500. A characteristic of the module design of these components is that each application can be displayed independently as well as in combinations. By way of example, the Channel Browser can be shown on screen without showing the Ticker-Tape. By way of further example, the Info+ Bar can also be shown on screen by itself, displaying information about the current channel by default.

The arrangements of the channel browser bar, Info+ Bar, TickerTape and help bar shown in FIGS. 3-5 are provided by way of example and without limitation. These components may be arranged differently. For example, the TickerTape could be horizontally disposed along the bottom of the television screen and the help bar could be disposed horizontally along the top of the television screen.

The various aspects of the interface described herein may be implemented as part of an operating program executed by control section 114. This program can, for example, be tangibly embodied or stored on a computer-readable medium such as memory 120. Memory 120 may include magnetic memory, optical memory, semiconductor memory, magneto-optic memory, combinations thereof and the like. In another example, the program may be available for downloading over the internet so that the program may be delivered to television 100 via a communication network. Updates to the interface may be provided via downloads to television 100. Further, a carrier wave may be modulated by a signal representing the corresponding program and an obtained modulated wave may be transmitted, so that the television that receives the modulated wave may demodulate the modulated wave to restore the corresponding program.

While the systems and methods have been described in connection with what is presently considered to practical and preferred embodiments, it is to be understood that these systems and methods are not limited to the disclosed embodiments, but on the contrary, is intended to cover various modifications and equivalent arrangements included within the spirit and scope of the appended claims.

I claim:

1. A television user interface comprising:
a channel list vertically disposed on a television screen;
an input device for receiving inputs for selecting a channel on the channel list; and
an information bar horizontally disposed on the television screen in correspondence with a selected channel, the information bar provides information about programming on the selected channel.

2. The user interface according to claim 1, wherein the information bar provides information about a current program on the selected channel.

3. The user interface according to claim 1, wherein the information bar provides information about a future program on the selected channel.

4. The user interface according to claim 1, wherein the information bar provides information about a past program on the selected channel.

5. The user interface according to claim 1, further comprising:
a scrolling ticker tape horizontally disposed along the top or the bottom of the television screen.

6. The user interface according to claim 5, wherein the ticker tape provides information regarding future programs.

7. The user interface according to claim 1, further comprising:
a help bar horizontally disposed along the top or bottom of the television screen.

8. The user interface according to claim 7, wherein contents of the help bar change in accordance with whether focus is on the channel browser bar or the information bar.

9. A television comprising:
a channel list module for displaying a channel list which is vertically disposed on a television screen;
an information bar module for displaying an information bar which is horizontally disposed on the television screen in correspondence with a selected channel, the information bar provided information about programming on the selected channel; and
a processing system for executing the channel list and information bar modules.

10. The television according to claim 9, wherein the information bar provides information about a current program on the selected channel.

11. The television according to claim 9, wherein the information bar provides information about a future program on the selected channel.

12. The television according to claim 9, wherein the information bar provides information about a past program on the selected channel.

13. The television according to claim 9, further comprising:
a scrolling ticker tape module for displaying a scrolling ticker tape which is horizontally disposed along the top or the bottom of the television screen.

14. The television according to claim 13, wherein the ticker tape provides information regarding future programs.

15. The television according to claim 9, further comprising:
a help bar module for displaying a help bar which is horizontally disposed along the top or bottom of the television screen.

16. The television according to claim 15, wherein contents of the help bar change in accordance with whether focus is on the channel browser bar or the information bar.
